(19) United States
(12) Patent Application Publication
(10) Pub. No.: US 2014/0016078 A1
(43) Pub. Date: Jan. 16, 2014

(54) LIQUID CRYSTAL COMPOSITION, LIQUID CRYSTAL DISPLAY PANEL AND FABRICATING METHOD THEREOF

(71) Applicants: Chun-Wei Su, New Taipei City (TW); Kai-Hsien Yang, Taipei City (TW); Jan-Tien Lien, Keelung City (TW)

(72) Inventors: Chun-Wei Su, New Taipei City (TW); Kai-Hsien Yang, Taipei City (TW); Jan-Tien Lien, Keelung City (TW)

(73) Assignee: CHUNGHWA PICTURE TUBES, LTD., Taoyuan (TW)

(21) Appl. No.: 13/615,646

(22) Filed: Sep. 14, 2012

(30) Foreign Application Priority Data
Jul. 12, 2012 (TW) 101125130

(51) Int. Cl. C09K 19/54; G02F 1/1341; G02F 1/1333

(52) U.S. Cl. 349/158; 349/189; 252/299.5

(57) ABSTRACT

A liquid crystal display panel including a first substrate, a second substrate, a liquid crystal molecule layer, a first liquid crystal cell layer and a second liquid crystal cell layer is provided. The second substrate is disposed opposite to the first substrate. The liquid crystal molecule layer has a plurality of liquid crystal molecules and disposed between the first substrate and the second substrate. The first liquid crystal cell layer has a plurality of first liquid crystal cells and disposed between the first substrate and the liquid crystal molecule layer. The second liquid crystal cell layer has a plurality of second liquid crystal cells and disposed between the second substrate and the liquid crystal molecule layer. Moreover, a liquid crystal composition used to make the liquid crystal display panel and a fabricating method of liquid crystal panel are also provided.

### CROSS-REFERENCE TO RELATED APPLICATION

This application claims the priority benefit of Taiwan application serial no. 101125130, filed on Jul. 12, 2012. The entirety of the above-mentioned patent application is hereby incorporated by reference herein and made a part of this specification.

### BACKGROUND OF THE INVENTION

1. Field of the Invention

The disclosure relates to a mixture, an optoelectronic device and a fabricating method thereof, and more particularly, to a liquid crystal composition, a liquid crystal display panel and a fabricating method thereof.

2. Description of the Prior Art

Currently, several methods can produce flexible displays. In the modern development of flexible display fabricating technology, polymer dispersed liquid crystal display (PDLC) process, polymer stabilized liquid crystal display (PSLC) process, microcapsule method, and microcup are mostly used in the industry.

In the cases of conventional polymer dispersed liquid crystal display process and conventional polymer stabilized liquid crystal display process, since the distributions of polymer phase and the liquid crystal phase are not easily controlled, and the polymer dispersed liquid crystal display and polymer stabilized liquid crystal display has drawbacks of low contrast and high driving voltage. In addition, the conventional polymer dispersed liquid crystal display and conventional polymer stabilized liquid crystal display further have a drawback of large thickness.

### SUMMARY OF THE INVENTION

In light of the above, the invention is directed to a liquid crystal composition, the liquid crystal display panel fabricated by this liquid crystal composition has low driving voltage, small thickness and good optical properties.

The invention is directed to a liquid crystal display panel having low driving voltage, small thickness and good optical properties.

The present invention is directed to a fabricating method of liquid crystal display panel, the liquid crystal display panel fabricated by this fabricating method has high production yield and low production cost.

The invention provides a liquid crystal composition, in which the liquid crystal composition includes a plurality of liquid crystal molecules and a polymerizable material. The polymerizable material includes an organic solvent, a polyol acrylate oligomer, a difunctional acrylate monomer, a polythiol monomer and a photo-initiator. A weight percent of the polymerizable material related to a total weight of the liquid crystal composition ranges from 20% to 50%. A weight percent of the polyol acrylate oligomer related to a total weight of the polymerizable material ranges from 10% to 30%. A weight percent of the difunctional acrylate monomer related to the total weight of the polymerizable material ranges from 10% to 30%. A weight percent of the polythiol monomer related to the total weight of the polymerizable material ranges from 10% to 30%. A weight percent of the photo-initiator related to the total weight of the polymerizable material ranges from 0.5% to 5%.

The invention provides a fabricating method of liquid crystal display panel including the following steps. A first substrate is provided. A second substrate is provided. The first substrate and the second substrate are assembled. The above-mentioned liquid crystal composition is provided. The liquid crystal composition is filled between the first substrate and the second substrate. A light-beam is irradiated to the liquid crystal composition, so that polymerization reaction occurs between a part of the liquid crystal molecules.

The invention provides a liquid crystal display panel, in which the liquid crystal display panel includes a first substrate, a second substrate, a liquid crystal molecule layer, a first liquid crystal cell layer and a second liquid crystal cell layer. The second substrate is disposed opposite to the first substrate. The liquid crystal molecule layer has a plurality of liquid crystal molecules and is disposed between the first substrate and the second substrate. The first liquid crystal cell layer has a plurality of first liquid crystal cells and is disposed between the first substrate and the liquid crystal molecule layer. The second liquid crystal cell layer has a plurality of second liquid crystal cells and is disposed between the second substrate and the liquid crystal molecule layer.

According to an embodiment of the invention, the polyol acrylate oligomer includes:

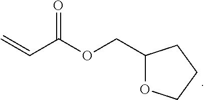

According to an embodiment of the invention, the difunctional acrylate monomer includes:

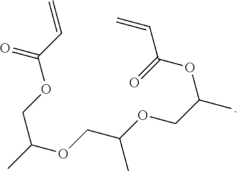 [SMILES: C=CC(=O)OCC(C)OCC(C)OCC(C)OC(=O)C=C]

According to an embodiment of the invention, the polythiol monomer includes:

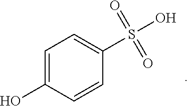 [SMILES: O=S(=O)(O)c1ccc(O)cc1]

According to an embodiment of the invention, the photo-initiator includes:

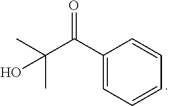

According to an embodiment of the invention, the step of irradiating a light-beam to the liquid crystal composition to react the polymerization of the part of liquid crystal molecules includes the following steps. The part of liquid crystal molecules form a plurality of liquid crystal cells on surfaces of the first substrate and the second substrate by the polyol acrylate oligomer; and the liquid crystal molecules within the liquid crystal cells are polymerized with the polyol acrylate oligomer by using the difunctional acrylate monomer.

According to an embodiment of the invention, the light-beam is an ultraviolet beam.

According to an embodiment of the invention, the first liquid crystal cells and second liquid crystal cells are formed by a part of the liquid crystal molecules, the difunctional acrylate monomer and the polyol acrylate oligomer.

According to an embodiment of the invention, the liquid crystal display panel further includes a polythiol monomer disposed between the first substrate and the second substrate.

According to an embodiment of the invention, the first substrate is an active device array substrate.

According to an embodiment of the invention, the second substrate has a transparent conductive layer.

According to an embodiment of the invention, when a potential difference exists between the first substrate and the second substrate and is greater than zero, optical axes of the liquid crystal molecules of the liquid crystal molecule layer are substantially in conformity with optical axes of the part of the liquid crystal molecules forming the first liquid crystal cells and the second liquid crystal cells.

According to an embodiment of the invention, when a potential difference substantially equal to zero exists between the first substrate and the second substrate, optical axes of the liquid crystal molecules of the liquid crystal molecule layer are staggered to optical axes of the part of the liquid crystal molecules forming the first liquid crystal cells and the second liquid crystal cells.

Based on the above, in the liquid crystal display panel in one embodiment of the present invention, since the liquid crystal cells are formed on the surfaces of the first substrate and the second substrate, and the liquid crystal molecules located near the central region of the first substrate and second substrate are still shown as general states of liquid crystal molecules, the driving voltage of the liquid crystal display panel in one embodiment of the present invention can be reduced and the thickness thereof can be thinned.

Moreover, in the fabricating method of liquid crystal display panel in one embodiment of the present invention, a liquid crystal display panel having low driving voltage and thin thickness can be produced by using the specially designed liquid crystal composition.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A to FIG. 1F are schematic views illustrating a fabricating process of liquid crystal display panel according to an embodiment of the invention.

FIG. 2A to FIG. 2B are schematic section views of liquid crystal display panel according to an embodiment of the invention.

FIG. 3 shows a relation between the transmittance and the driving voltage of test cell of liquid crystal display panel according to an embodiment of the invention.

### DETAILED DESCRIPTION OF DISCLOSED EMBODIMENTS

Fabricating Method of Liquid Crystal Display Panel

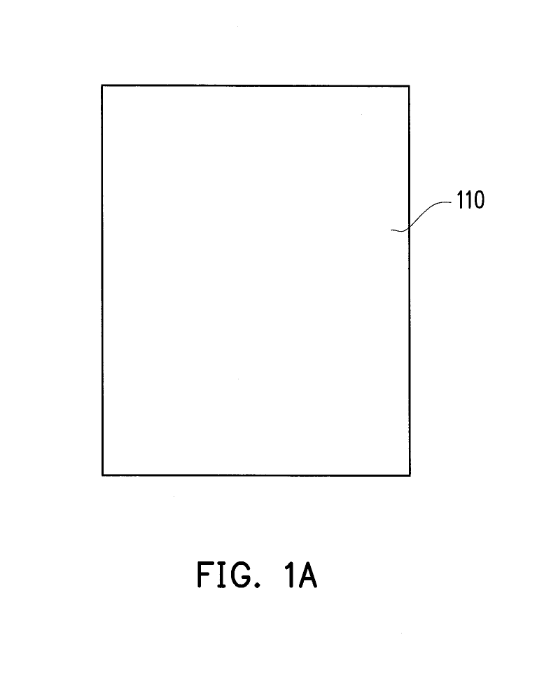

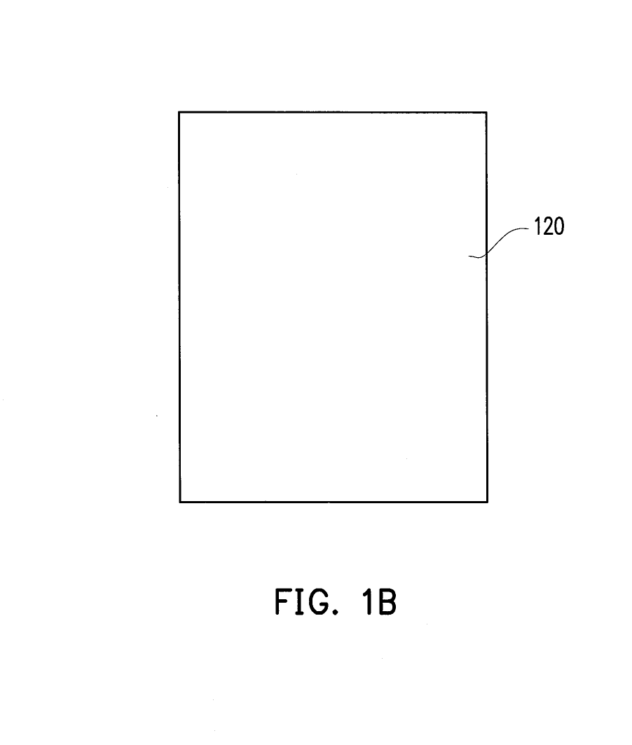

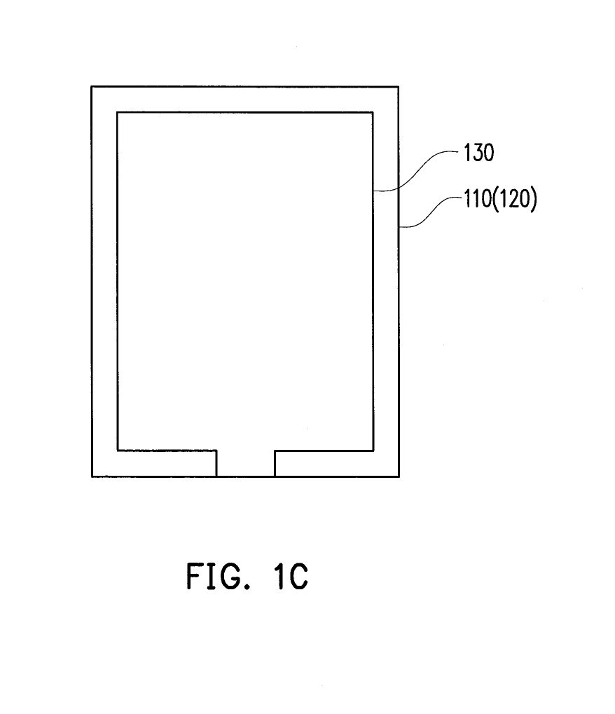

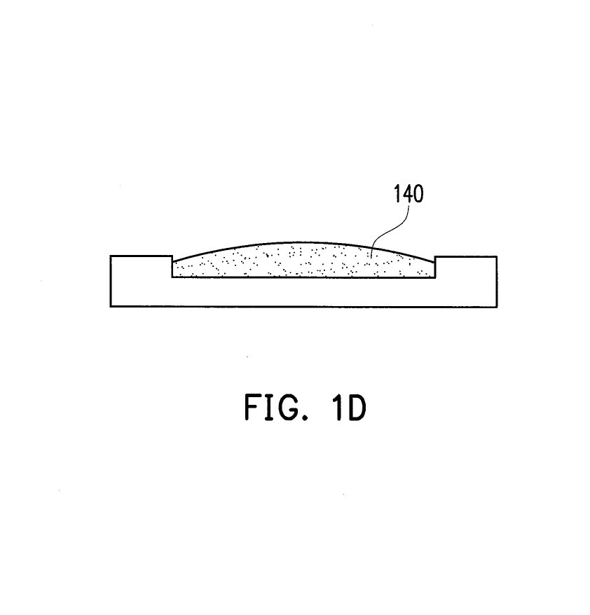

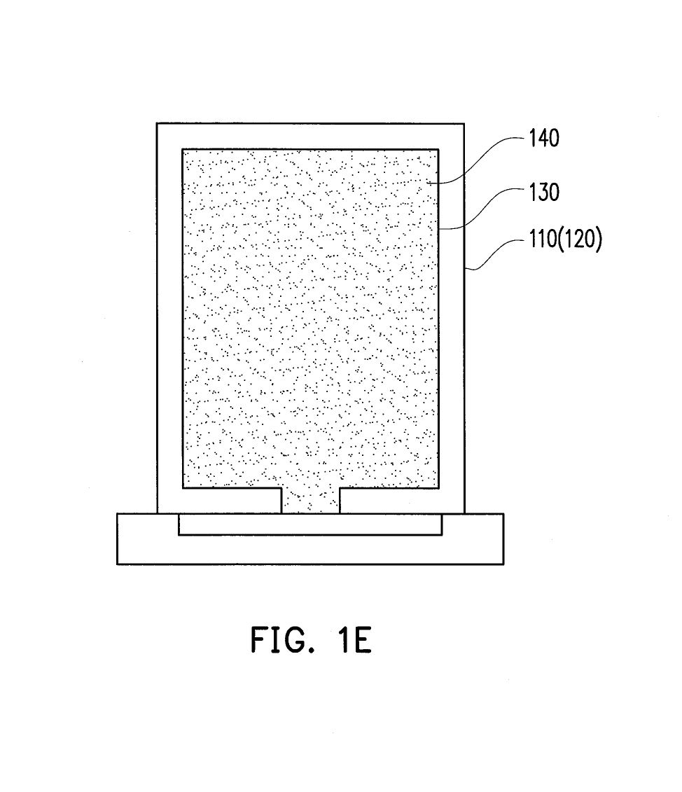

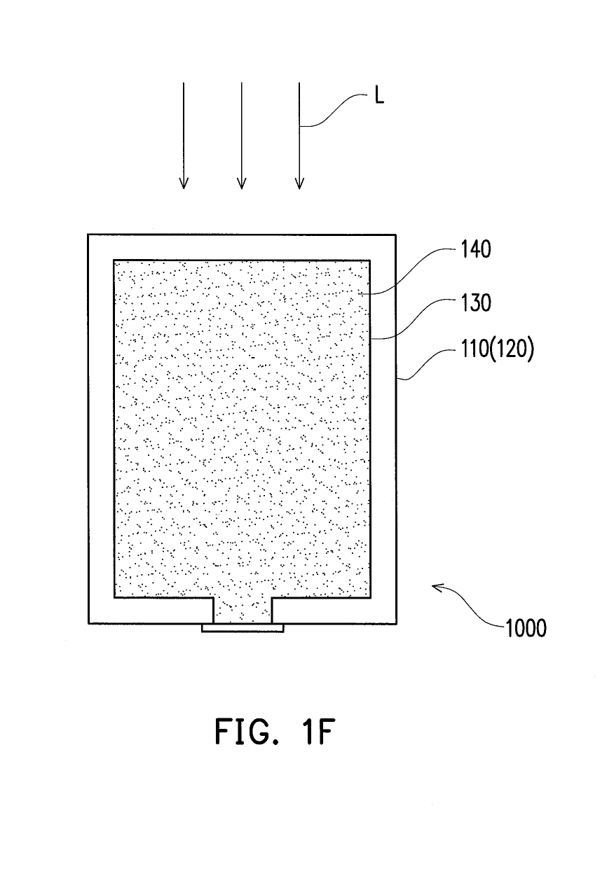

FIG. 1A to FIG. 1F are schematic views illustrating a fabricating process of liquid crystal display panel according to an embodiment of the invention. Referring FIG. 1A, a first substrate 110 is provided first. In this embodiment, the first substrate 110 can be an active device array substrate. More specifically, the active device array substrate may have a plurality of active devices (i.e. thin film transistors) arranged in an array and have a plurality of pixel electrodes electrically connected to the active devices. The materials of the pixel electrodes can be transparent conductive materials, such as indium tin oxide, indium zinc oxide, aluminum tin oxide, aluminum zinc oxide, indium germanium zinc oxide, or other suitable oxide, or a stacked layer of at least two above materials, but the present invention is not be limited.

Referring to FIG. 1B, the second substrate 120 is then provided. In this embodiment, the second substrate 120 includes a base and a transparent conductive layer disposed on the base. The suitable materials of the transparent conductive layer are similar to that of the pixel electrodes, and are not restated herein. However, the present invention is not limited to this, in other embodiments, the second substrate 120 can optionally include a color filter layer disposed between the base and the transparent conductive layer.

Referring to FIG. 1C, the first substrate 110 and the second substrate 120 are then assembled. More specifically, a sealant 130 can be coated on the first substrate 110 firstly in this embodiment, and then the second substrate 120 is aligned to the first substrate 110. After that, the second substrate 120 is connected to the first substrate 110 through the sealant 130. Finally, the sealant 130 is cured, so as to accomplish the assembly of the first substrate 110 and the second substrate 120.

Referring to FIG. 1D, after that, a liquid crystal composition 140 is provided. The liquid crystal composition 140 includes a plurality of liquid crystal molecules and a polymerizable material. The polymerizable material includes an organic solvent, a polyol acrylate oligomer, a difunctional acrylate monomer, a polythiol monomer and a photo-initiator. Based on the total weight of the liquid crystal composition 140, the weight percentage of the polymerizable material can range from 20% to 50%. Based on the total weight of the polymerizable material, the weight percentage of the polyol acrylate oligomer can range from 10% to 30%. Based on the total weight of the polymerizable material, the weight percentage of the difunctional acrylate monomer can range from 10% to 30%. Based on the total weight of the polymerizable material, the weight percentage of the polythiol monomer can range from 10% to 30%. Based on the total weight of the polymerizable material, the weight percentage of the photo-initiator can range from 0.5% to 5%. In this embodiment, the polymerizable material has low viscosity coefficient, and is classified a low molecular structural state. The viscosity coefficient of the polymerizable material can be 100 mPa·seconds (mPa·s).

The characteristics of the polyol acrylic monomer tend to surfactants. The main function of the polyol acrylic oligomer is to make the liquid crystal molecules to form low molecular liquid crystal cells on the surfaces of the first substrate 110 and the second substrate 120. The main function of the difunctional acrylate monomer is to make the liquid crystal molecules within the low molecular liquid crystal cells more effective in polymerization with the polyol acrylic oligomer. The main function of the polythiol monomer is to strengthen the adhesion between low molecular liquid crystal cells and surfaces of the first substrate 110 and the second substrate 120. The main function of the photo-initiator is to increase reaction rates between the various components of the liquid crystal composition 140. In this embodiment, the polyol acrylate oligomer includes C₈H₁₂O₃, and the structural formula may be:

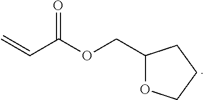

The difunctional acrylate monomer includes C₁₅H₂₄O₆, and the structural formula may be:

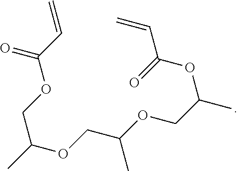 [SMILES: C=CC(=O)OCC(C)OCC(C)OCC(C)OC(=O)C=C]

The polythiol monomer includes C₆H₆O₄S, and the structural formula may be:

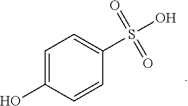 [SMILES: O=S(=O)(O)c1ccc(O)cc1]

The photo-initiator includes C₁₀H₁₂O₂, and the structural formula may be:

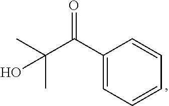

however, the present invention is not limited to.

Referring to FIG. 1E, a liquid crystal composition 140 is then filled between the first substrate 110 and the second substrate 120. In this embodiment, the liquid crystal composition 140 may be filled between the first substrate 110 and the second substrate 120 by the vacuum injection method. However, the present invention is not limited to. In other embodiments, the liquid crystal composition 140 may be filled between the first substrate 110 and the second substrate 120 by one drop fill (ODF) method or other appropriate methods.

Referring to FIG. 1F, the liquid crystal composition 140 is irradiated by a light-beam L afterward, so that polymerization reaction occurs between a part of the liquid crystal molecules. In detail, in this embodiment, first, the polyol acrylate oligomer can make a part of the liquid crystal molecules to form a plurality of liquid crystal cells (not shown in FIG. 1F) on surfaces of the first substrate 110 and the second substrate 120, and then the difunctional acrylate monomer can make the liquid crystal molecules within the low molecular liquid crystal cells more effective in polymerization with the polyol acrylic monomer. In this embodiment, the light-beam L may be an ultraviolet (UV) light light-beam. Thus, the liquid crystal display panel 1000 of the present embodiment is accomplished.

It should be noted that, compared to the conventional fabricating method of liquid crystal display panel, the fabricating method of liquid crystal display panel of this embodiment does not require any alignment film and any polarizer. Therefore, compared to the conventional liquid crystal display panel, the liquid crystal display panel of this embodiment has advantages of simple process, high yield and low production cost.

Liquid Crystal Display Panel

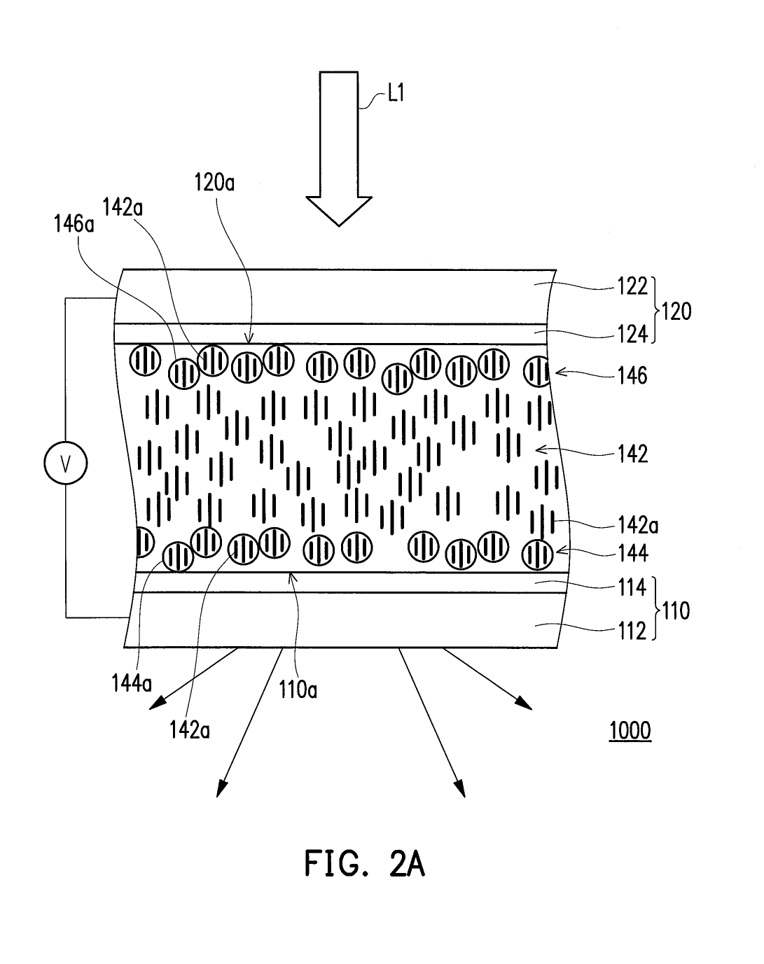

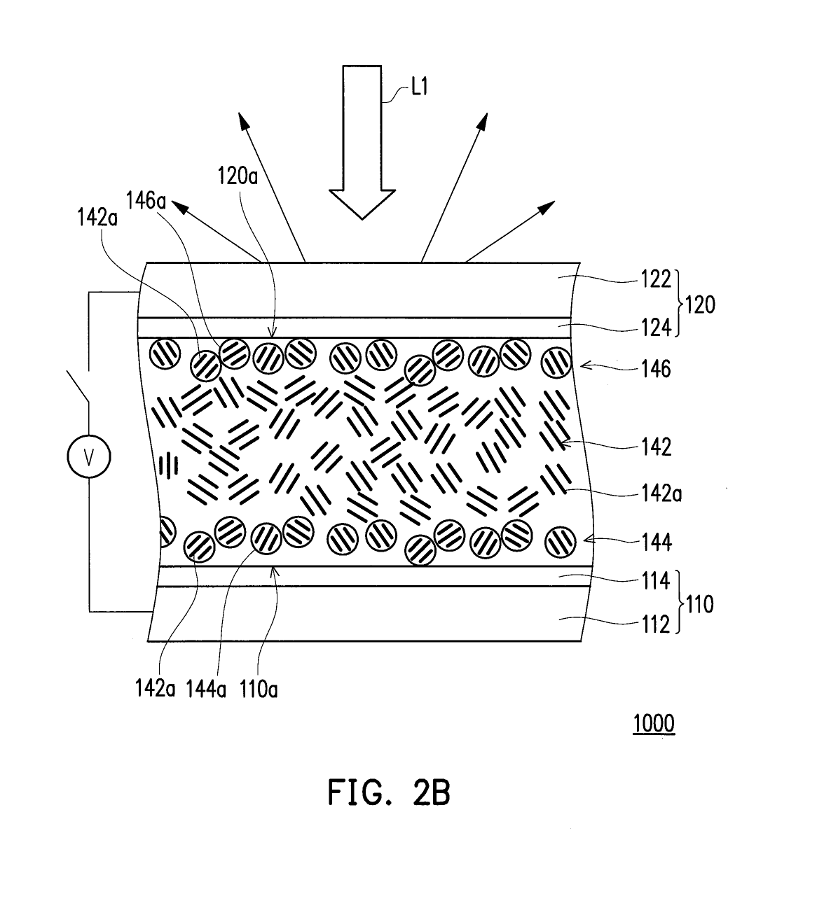

FIG. 2A to FIG. 2B are schematic section views of liquid crystal display panel according to an embodiment of the invention. Referring to FIG. 2A to FIG. 2B, the liquid crystal display panel 1000 of this embodiment includes a first substrate 110, a second substrate 120, a liquid crystal molecule layer 142, a first liquid crystal cell layer 144 and a second liquid crystal cell layer 146.

The first substrate 110 of this embodiment may be an active device array substrate. More specifically, the first substrate 110 includes a base 112, active device (not shown) disposed on the base 112, and pixel electrodes 114 electrically connected to active devices. In general, the materials of the pixel electrodes are mostly transparent conductive materials, such as indium tin oxide, indium zinc oxide, aluminum tin oxide, aluminum zinc oxide, indium germanium zinc oxide, or other suitable oxide, or a stacked layer of at least two above materials, but the present invention is not be limited.

The second substrate 120 is disposed opposite to the first substrate 110. In this embodiment, the second substrate 120 includes a base 122 and a transparent conductive layer 124 disposed on the base. The available materials of the transparent conductive layer are similar to that of the pixel electrodes, and are not restated herein. However, the present invention is not limited to this, in other embodiments, the second substrate 120 can further include a color filter layer disposed between the base and the transparent conductive layer.

The liquid crystal molecule layer 142 has a plurality of liquid crystal molecules 142a and is disposed between the first substrate 110 and the second substrate 120. The first liquid crystal cell layer 144 has a plurality of first liquid crystal cells 144a and is disposed between the first substrate 110 and the liquid crystal molecule layer 142. The second liquid crystal cell layer 146 has a plurality of second liquid crystal cells 146a and is disposed between the second substrate 120 and the liquid crystal molecule layer 142. It should be noted that, in the liquid crystal display panel 1000 of this embodiment, the first liquid crystal cells 144a and the second liquid crystal cells 146 are formed on the surfaces 110a, 120a of the first substrate 110 and the second substrate 120. Therefore, the cell gap of the liquid crystal display panel 1000 in this embodiment can be shortened, and thus the overall thickness of the liquid crystal display panel 1000 of this embodiment can also be reduced. The cell gap of the liquid crystal display panel 1000 of this embodiment may be range from 4 μm to 10 μm. Moreover, since the liquid crystals 142a located near the central region of the first substrate 110 and second substrate 120 are shown as the general states of liquid crystal molecules, rather than shown as the states of liquid crystal cells, and thus the driving voltage may be significantly reduced. In addition, a design of active device array substrate may be used to the first substrate 110 of the liquid crystal display panel 1000.

The liquid crystal display panel 1000 is fabricated by the above-mentioned fabricating method of liquid crystal display panel. In other words, the first liquid crystal cells 144a and the second liquid crystal cells 146a are formed by a part of the liquid crystal molecules 142a, the difunctional acrylate monomers and polyol acrylate oligomers. Moreover, the liquid crystal display panel 1000 of this embodiment further includes the polythiol monomers (not shown) disposed between the first substrate 110 and the second substrate 120. The polythiol monomers can enhance the adhesions of the first liquid crystal cells 144a and the second liquid crystal cells 146a adhered to the surfaces 110a, 120a of the first substrate 110 and the second substrate 120, and the display effect of the liquid crystal display panel 1000 of this embodiment may be further improved.

FIG. 2A is a schematic view of liquid crystal display panel according to an embodiment of the invention in a transparent state. Referring to FIG. 2A, when a potential difference V exists between the first substrate 110 and the second substrate 120 is greater than zero, the optical axes of the liquid crystal molecules 142a of the liquid crystal molecule layer 142 are substantially in conformity with optical axes of the part of the liquid crystal molecules 142a forming the first liquid crystal cells 144a and the second liquid crystal cells 146a. At this time, when the incident light L1 is passed to the LCD panel 1000, the incident light L1 passes through the second substrate 120, the second liquid crystal cell layer 146, the liquid crystal molecule layer 142, the first liquid crystal cell layer 144 and the first substrate 110, so that part of the region of the liquid crystal display panel 1000 shows a transparent state.

FIG. 2B is a schematic view of liquid crystal display panel according to an embodiment of the invention in a scattering state. Referring to FIG. 2B, when the potential difference V exists between the first substrate 110 and the second substrate 120 and is substantially equal to zero, the optical axes of the liquid crystal molecules 142a of the liquid crystal molecule layer 142 are staggered to optical axes of the part of the liquid crystal molecules 142a forming the first liquid crystal cells 144a and the second liquid crystal cells 146a. In other words, the distribution of the optical axes directions of liquid crystal molecules 142a in the second liquid crystal cell layer 146 is messy. Therefore, when the incident light L1 is passed to the LCD panel 1000, the incident light L1 will be scattered by the second liquid crystal cell layer 146, so that part of the region of the liquid crystal display panel 1000 shows a scattering state. By the way of controlling a part of the region of the liquid crystal display panel 1000 showing the transparent and controlling a part of the region of the liquid crystal display panel 1000 showing scattering states, the liquid crystal display panel 1000 can display without using polarizers. As such, the liquid crystal display panel 1000 of this embodiment has more advantages of low cost.

### Experiments

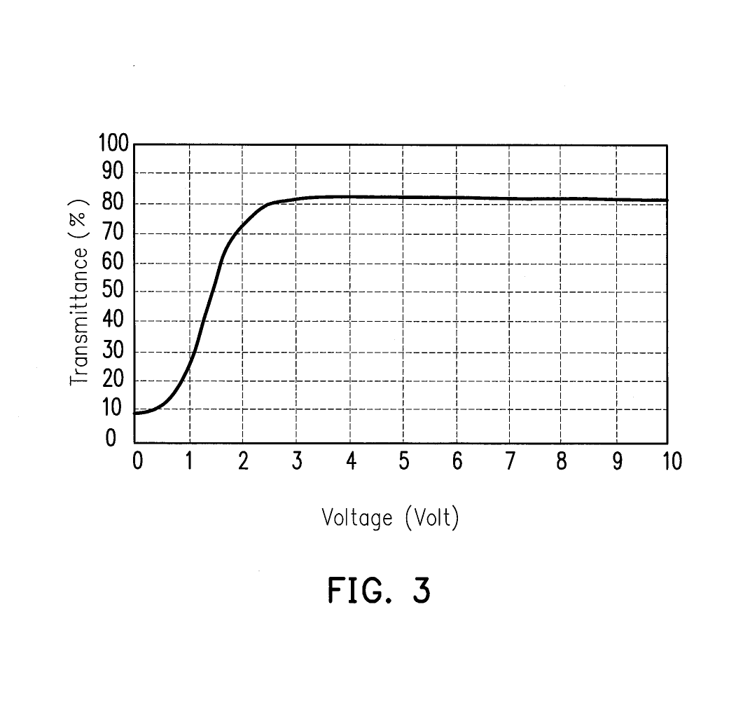

FIG. 3 shows a relation between the transmittance and the driving voltage of test cell of liquid crystal display panel according to an embodiment of the invention. The above test cell includes a first substrate having a conductive film, a second substrate having a conductive film and disposed opposite to the first substrate, and a liquid crystal composition filled between the first substrate and the second substrate, and the test cell has gone through the above-mentioned irradiating process. As shown in FIG. 3, after a proper process of liquid crystal composition, the driving voltage is close to 3 volts, and the contrast of the test cell is up to 10. In other words, it may be proved that by the relation between the transmittance and the driving voltage of test cell, liquid crystal composition is indeed applicable to the active-matrix liquid crystal display, and the active-matrix liquid crystal display fabricated by the liquid crystal composition has excellent optical properties.

To sum up, in the liquid crystal display panel in one embodiment of the present invention, since the liquid crystal cells are formed on the surfaces of the first substrate and the second substrate, and the liquid crystal molecules located near the central region of the first substrate and second substrate are still shown as the general states of liquid crystal molecules, and thus the driving voltage of the liquid crystal display panel in one embodiment of the present invention may be reduced and the thickness thereof may be thinned.

Furthermore, in the fabricating method of liquid crystal display panel in one embodiment of the present invention, a liquid crystal display panel having low driving voltage and thin thickness may be produced by using the specially designed liquid crystal composition.

It will be apparent to those skilled in the art that various modifications and variations may be made to the structure of the invention without departing from the scope or spirit of the invention. In view of the foregoing, it is intended that the present invention cover modifications and variations of this invention provided they fall within the scope of the following claims and their equivalents.

1. A liquid crystal composition, comprising:
a plurality of liquid crystal molecules; and
a polymerizable material, comprising;
an organic solvent;
a polyol acrylate oligomer;
a difunctional acrylate monomer;
a polythiol monomer; and
a photo-initiator, wherein a weight percent of the polymerizable material related to a total weight of the liquid crystal composition ranges from 20% to 50%, a weight percent of the polyol acrylate oligomer related to a total weight of the polymerizable material ranges from 10% to 30%, a weight percent of the difunctional acrylate monomer related to the total weight of the polymerizable material ranges from 10% to 30%, a weight percent of the polythiol monomer related to the total weight of the polymerizable material ranges from 10% to 30%, and a weight percent of the photo-initiator related to the total weight of the polymerizable material ranges from 0.5% to 5%.

2. The liquid crystal composition of claim 1, wherein the polyol acrylate oligomer comprises:

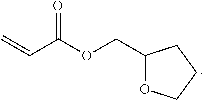

3. The liquid crystal composition of claim 1, wherein the difunctional acrylate monomer comprises:

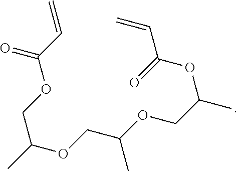 [SMILES: C=CC(=O)OCC(C)OCC(C)OCC(C)OC(=O)C=C]

4. The liquid crystal composition of claim 1, wherein the polythiol monomer comprises:

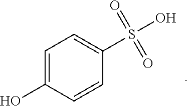 [SMILES: O=S(=O)(O)c1ccc(O)cc1]

5. The liquid crystal composition of claim 1, wherein the photo-initiator comprises:

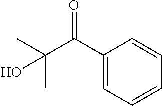

6. A fabricating method of liquid crystal display panel, comprising following steps:
providing a first substrate;
providing a second substrate;
assembling the first substrate and the second substrate;
providing a liquid crystal composition, wherein the liquid crystal comprises a plurality of liquid crystal molecules and a polymerizable material, the polymerizable material comprises an organic solvent, a polyol acrylate oligomer, a difunctional acrylate monomer, a polythiol monomer and a photo-initiator, wherein a weight percent of the polymerizable material related to a total weight of the liquid crystal composition ranges from 20% to 50%, a weight percent of the polyol acrylate oligomer related to a total weight of the polymerizable material ranges from 10% to 30%, a weight percent of the difunctional acrylate monomer related to the total weight of the polymerizable material ranges from 10% to 30%, a weight percent of the polythiol monomer related to the total weight of the polymerizable material ranges from 10% to 30%, and a weight percent of the photo-initiator related to the total weight of the polymerizable material ranges from 0.5% to 5%;
filling the liquid crystal composition between the first substrate and the second substrate; and
irradiating a light-beam to the liquid crystal composition, so that polymerization reaction occurs between a part of liquid crystal molecules.

7. The fabricating method of liquid crystal display panel of claim 6, wherein the step of irradiating a light-beam to the liquid crystal composition, so that polymerization reaction occurs between the part of liquid crystal molecules comprising:
the part of liquid crystal molecules forms a plurality of liquid crystal cells on surfaces of the first substrate and the second substrate by the polyol acrylate oligomer; and
the liquid crystal molecules within the liquid crystal cells are polymerized with the polyol acrylate oligomer by using the difunctional acrylate monomer.

8. The fabricating method of liquid crystal display panel of claim 6, wherein the light-beam is an ultraviolet light beam.

9. The fabricating method of liquid crystal display panel of claim 6, wherein the polyol acrylate oligomer comprises:

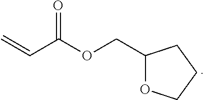

10. The fabricating method of liquid crystal display panel of claim 6, wherein the difunctional acrylate monomer comprises:

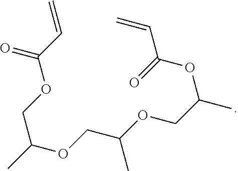 [SMILES: C=CC(=O)OCC(C)OCC(C)OCC(C)OC(=O)C=C]

11. The fabricating method of liquid crystal display panel of claim 6, wherein the polythiol monomer comprises:

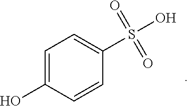 [SMILES: O=S(=O)(O)c1ccc(O)cc1]

12. The fabricating method of liquid crystal display panel of claim 6, wherein the photo-initiator comprises:

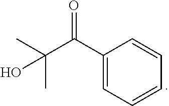

13. A liquid crystal display panel, comprising:
a first substrate;
a second substrate, disposed opposite to the first substrate;
a liquid crystal molecule layer, having a plurality of liquid crystal molecules and disposed between the first substrate and the second substrate;
a first liquid crystal cell layer, having a plurality of first liquid crystal cells and disposed between the first substrate and the liquid crystal molecule layer; and
a second liquid crystal cell layer, having a plurality of second liquid crystal cells and disposed between the second substrate and the liquid crystal molecule layer.

14. The liquid crystal display panel of claim 13, wherein the plurality of first liquid crystal cells and the plurality of second liquid crystal cells are formed by a part of the liquid crystal molecules, a difunctional acrylate monomer and a polyol acrylate oligomer.

15. The liquid crystal display panel of claim 14, further comprising a polythiol monomer, disposed between the first substrate and the second substrate.

16. The liquid crystal display panel of claim 13, wherein the first substrate is an active device array substrate.

17. The liquid crystal display panel of claim 13, wherein the second substrate has a transparent conductive layer.

18. The liquid crystal display panel of claim 13, wherein optical axes of the liquid crystal molecules of the liquid crystal molecule layer are substantially in conformity with optical axes of the part of the liquid crystal molecules forming the first liquid crystal cells and the second liquid crystal cells when a potential difference greater than zero is formed between the first substrate and the second substrate.

19. The liquid crystal display panel of claim 13, wherein optical axes of the liquid crystal molecules of the liquid crystal molecule layer are staggered to optical axes of the part of the liquid crystal molecules forming the first liquid crystal cells and the second liquid crystal cells when a potential difference substantially equal to zero is formed between the first substrate and the second substrate.
